(19) United States
(12) Patent Application Publication
(10) Pub. No.: US 2025/0022076 A1
(43) Pub. Date: Jan. 16, 2025

(54) METHOD AND SYSTEM FOR MANAGING CONSTRUCTION PROJECTS WITH AUTOMATIC GENERATION OF SMART CONTRACT

(71) Applicant: Build Trust S.R.L., Minerbe (IT)

(72) Inventor: Federico FURLANI, Minerbe (IT)

(21) Appl. No.: 18/681,024

(22) PCT Filed: Jul. 27, 2022
(86) PCT No.: PCT/EP2022/071055

§ 371 Date: Feb. 2, 2024

(30) Foreign Application Priority Data
Aug. 3, 2021 (IT) 102021000021011

(51) Int. Cl. G06Q 50/08; G06Q 10/0631; G06Q 20/38; G06Q 20/40

(52) U.S. Cl. CPC G06Q 50/08; G06Q 10/06313; G06Q 20/389; G06Q 20/40

(57) ABSTRACT

Method and system for the design, execution and monitoring of works, particularly in the construction field, through the modeling of projects by means of a BIM system integrated with the construction engineering necessary to configure all the systems and equipment required for construction, including automatic generation of smart contracts starting form a contract document. In a preferred embodiment of the present invention the automatic generation of a smart contract is performed by means of SysML (System Modeling Language) tool. IoT and/or Blockchain technologies are combined with conventional BIM systems for more precise monitoring and traceability of the stages in construction. The system and method according to a preferred embodiment of the present invention use the information collected by a plurality of detectors. The plurality of detectors preferably includes IoT devices. Detectors can be associated with any machinery used for the project and may include, for example, image acquisition devices such as cameras, remote cameras or web-cams fixed or mounted on drones; other possible detectors may be worn by construction staff. Detectors may also receive information from meteorological and/or seismographic services for a geographical area linked to at least one project.

### TECHNICAL FIELD

The present invention relates to a method and system for planning, managing and monitoring the phases and the financials (through automatic payments) of a construction project, more specifically a method and system for managing projects in the field of construction, following their progress over time, through the use of IoT devices, SysML, blockchain/smart contract.

### PRIOR ART

The Construction Industry, with its complexity, is showing a significant delay compared to many other business sectors with regards to automation and productivity improvement. As a consequence the profitability of the companies operating in this area of business are adversely affected. The origin of the problems finds its roots in the difficult definition of a sound value of each project, so that the awarding process is based on the minimum price ratio. In this way projects are driven inevitably towards schedule delays and rising costs because of unknown and underestimated risk and variations. The contraposition of owners and purchasers looking for the minimum price and the competition among the contractors and suppliers aiming to obtain contracts primarily on low cost alone, is an obstacle to the adoption of transparent and rational criteria to recognize the right value of a project. Recognizing the right value to projects for the whole supply chain and ensuring payments on time to all the actors involved is the key element to complete the jobs on time, in budget and quality. This aspect is not sufficiently addressed by the prior art methods and systems.

The design, implementation and control of the execution of major works (e.g. in the construction sector) involves management of complexity that is only partly assisted by modern integrated data processing systems. So-called BIM (Building Information Modeling) systems are revolutionizing the civil engineering sector, incorporating sets of information organized in databases that are becoming increasingly integrated into the design of construction works. There is no single or internationally recognized definition of BIM, although attempts are under way to develop a standard definition accepted by many operators and possibly regulated by law. At least, BIM means an integrated structure of systems and software that enables the elements of a project for works to be represented digitally, mainly in the construction field (e.g. buildings, bridges, dams, roads, industrial plants), with the aim of helping and facilitating the design, construction and control of the works and related decisions.

As a rule, the planning of a construction project developed with a BIM system becomes difficult to check when the work is under way because it relies on monitoring the stages in progress through the work of people, professionals, project managers, inspectors, etc., who confirm whether the work envisaged in the BIM has actually been performed or not. At present there is no digital certification for this information and, even less so, for contracting linked to this monitoring that can ensure compliance with the terms of supply.

What is lacking is a structured modeling approach that, in addition to collecting data, analyses it in detail symmetrically with the BIM model, monitoring time, costs and quality, as well as compliance with site safety and environmental regulations, in real time, in digital mode, generating a database of information.

The object of the present invention is to provide technology and frameworks that at least partly overcomes the disadvantages of currently available systems.

### SUMMARY OF THE INVENTION

According to the present invention we provide a method for managing and monitoring the execution of at least one project comprising a plurality of activities, by means of a distributed system comprising a plurality of detectors connected with a server, each of the plurality of detectors being adapted to measure at least one operating parameter related to one of the plurality of activities and to transmit the value of the at least one measured operating parameter at predetermined time intervals to the server, the method comprising the steps of: maintaining, for each project, in a database accessible from the server, at least one project definition document, defining a plurality of project specific constraints and at least one modelled contract document, each modelled contract document containing modelled definitions of at least two parties and a plurality of obligations related to the plurality of activities, the modelled definitions being compliant to a predetermined digital modeling language; for each project automatically generating, by means of a digital modelling system adapted to interpret the predetermined digital modelling language, a smart contract, the smart contract being based on the at least one project definition and the at least one modelled contract document, the smart contract defining a list of activities, each activity having a plurality of associated operating parameters and for each associated operating parameter an expected value based on the time elapsed since the beginning of the activity, the smart contract defining the payments to be authorized when the expected values are reached, each of the operating parameters being associated with at least one of the plurality of sensors; processing, in a traceable and secure way, by the server the values of the parameters received from the plurality of sensors and calculating for each parameter a deviation from the expected value; determining by the server a value representative of the total deviation with respect to the plurality of expected values; responsive to a predetermined threshold being exceeded by the value representative of the total deviation, executing a predetermined corrective action procedure; or responsive to the predetermined threshold not being exceeded by the value representative of the total deviation, authorizing the payment associated to the expected values. This can be done through the modelling of projects by means of a BIM system integrated with the construction engineering necessary to configure all the systems and equipment required for construction. A key point is to digitally connect Financials to the dynamic BIM forecast and to the IoT measurement. IoT and Blockchain/Smart Contract technologies are combined with conventional BIM systems for more precise monitoring and traceability of the stages in construction and to automatize payments.

In a preferred embodiment, the method is based on a Building Information Modelling (BIM) system and is preferably integrated with a Blockchain for the traceable and unmodifiable management of the progress steps of the project and integration with the financial aspects of the project. Preferably, the server and/or at least one of the detectors are connected and exchange information in a traceable and secure way by means of a Blockchain system. The modelled contract can be automatically generated by means of a tool based on a modelling language (e.g. System Modelling Language, SysML) which transform a contract document written in natural language into a modelled contract adapted to be interpreted by a parser understanding SysML. Preferably, for each activity, the plurality of associated operating parameters include one or more of the following: a due date by which the activity must be completed; a quantity of the delivery (e.g., the cubic meters of delivered raw material); one or more parameters indicative of the quality of the delivery (e.g., the density of delivered raw material); one or more operational conditions of the delivery (e.g., the production speed of a delivered machinery); a geographical position of the destination where material should be delivered.

In a preferred embodiment of the present invention, the smart contract defines at least one milestone associated to each of the plurality of activities, each milestone being associated to at least one financial transaction, and the method further comprises: monitoring the real time progress of the plurality of activities to determine whether a milestone is reached; responsive to a milestone being reached, authorizing the at least one associated financial transaction.

The plurality of detectors preferably comprises IoT devices. The detectors can be associated to any device used for performing the project and can include for example image acquisition devices, such as cameras, video-cameras, webcams, possibly installed on a drone; other possible devices include personal wearable devices used by the workers on the project sites. It is also possible that the detectors receive information from device capable of providing meteorological and/or seismographic information of a geographical area linked to the at least one project. All these data are certified through a block chain and can be accessible by the all the stakeholders even after the project completion.

According to the present invention we also provide a computer program, an application software or a program product, adapted to perform a method for managing and monitoring the execution of at least one project comprising a plurality of activities, according to the method described above, when the program is executed on a computer, a smartphone or any other data processing system.

We also provide a distributed system comprising one or more components suitable for implementing a method for managing and monitoring the execution of at least one project comprising a plurality of activities, as described above.

With the present invention it is possible to implement a system which combines existing BIM tools with advanced technologies, such as for example IoT (Internet of Things) to realize a digital platform which is able to monitor and control the sustainability and the actual execution of intended project as defined in BIM system. In a preferred embodiment of the present invention, the Blockchain technology is used to trace and guarantee all the financial transactions in a safe and certified way.

The connection between financials and BIM/IOT is possible through the digital transformation of traditional contracts into frameworks and model that can be managed by System of Systems software (based on SysML language) which are commonly used in engineering simulations. The method according to a preferred embodiment of the present invention, starting from SysML, automatically generates smart contracts that automatically trigger payments when the IOT data from the field match the condition on the BIM.

The key point is to translate in digital contracts the primary contract (which usually is on paper), extracting all the payments conditions, triggers and key events that allows the connection between BIM e IOT. The generation of a smart contract from a traditional contract requires the modeling of paper-contract through a framework in SysML, from where can be implemented the automatic creation of the smart-contract and the embedding on the Blockchain.

### BRIEF DESCRIPTION OF THE FIGURES

These and further advantages, objects and features of the present invention will be better understood by a person skilled in the art from the following description and the attached drawings relating to examples of embodiments of an illustrative nature, that are not to be understood in a limiting sense, in which:

FIG. 1 illustrates the general architecture of a system according to a preferred embodiment of the present invention;

FIG. 2 shows diagrammatically a generic computer used in the system according to a preferred embodiment of the present invention;

FIG. 3 schematically shows a contract phases diagram in SysML;

FIG. 4 shows an example of modelling contracts through Process Phase Flow;

FIG. 5 shows a flow chart for a Smart Contract Management Flow;

FIG. 6 illustrates diagrammatically a management model according to the present invention;

FIG. 7 illustrates a scheme for the architecture of an embodiment of the present invention, based on eight conceptual nodes;

FIG. 8 is a different illustration of the model in FIG. 1 with of the eight nodes architecture of FIG. 7;

FIG. 9 shows illustrative graphs generated by a system according to a preferred embodiment of the present invention;

FIG. 10 illustrates diagrammatically the steps of a method according to a preferred embodiment of the present invention;

FIGS. 11-13 show examples of digital representations of a project site.

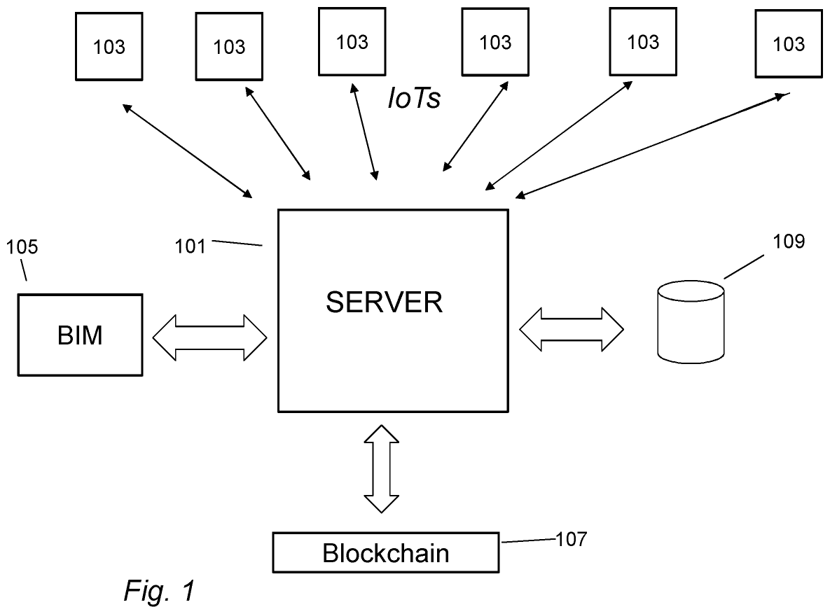

### DETAILED DESCRIPTION OF EMBODIMENTS OF THE INVENTION

According to a preferred embodiment of the present invention, we provide a platform that collect IOT data from the construction site and compare them with the BIM project, in order to automatically track the progress and deviation from the baseline. Embedded smart contracts connect the financial transactions to the construction events and everything is certified and trusted through a permissioned Blockchain. The solution, according to a preferred embodiment of the present invention, addresses several needs, including:
1. Real time project tracking and transparency
2. Real time financial tracking and payments
3. Contract and regulations data access
4. Trusted bidding process
5. Raw material traceability
6. Project risk management
7. Construction quality
8. Safety and Responsibility

Down below, the detail of the main aspects and benefits, referred to the above issues:
1. The real time project tracking and transparency allows the early discovery and understanding of the nature of the delays and highlight mitigation options, enabling the adaptation strategies. In constructions is nowadays crucial to anticipate and react to changes that result from the different players interactions and dependencies: the platform according to a preferred embodiment of the present invention can do this thanks to adaptation tracking and project impact forecasting.
2. Real time financial tracking and payments: the platform enables the project progress and payment tracking, avoiding the misalignment between budget, BIM, resources and actual forecasting. Financial transactions can be mapped to metrics of quality, quantity, safety and time throughout the project. This increases the reliability of successful project completion and loans repayment. Trusted blockchain data allow payments automation, improving cash flow to contractors and subcontractors, resolving the payment delays sickness; better communication between lenders and clients, as well as their clients, generate a virtuous business environment.
3. Contracts and regulations data access increase the transparency of projects for all participants and the respect of rules and compliance, thanks to more robust and seamless interactions and dependencies between players in all transactions. The real time oversight and notification, when contractual obligations are not met, and the non-biased oversight of contractual enforcements, can reduce dramatically litigation issue and expenses.
4. The bid transparency for all the stakeholders (financial institutions included) regarding project parameters, data needed, resources and other key variables, is mandatory to assure that the awarding process is based on a fair price and the bidding estimates are compatible with budgets and requirements. In this way, the whole ecosystem is aware of the reason why the contract was awarded. All the bidding process can be managed by the platform according to a preferred embodiment of the present invention, from the assessing reliability of contractors and sub-contractors, based on methods and resources, to discrepancies logging between tender parameters and delivered results.
5. Raw material traceability: real-time Supply chain monitoring and planning, raw material procurement transparency, quality control verification/compliance checking enforce and oversight simultaneously all environmental footprints. This allows to create sustainable and green procurement linked to lender requirements, regulations, and protocols.
6. Project risk management: the automatic verification of misalignment between budget, bid, resources, actual needs and forecasting overrides the critical transactions to BIM and schedule mapping, dramatically reducing construction risk. The platform enables also project time and resources estimation with high precision; it provides material and equipment requirements, availability forecasting in the pre-bid phase, as well as critical transactions identification and tracking.
7. Construction quality: real-time monitoring directly connected to the machines and equipment, bypassing human interference through linked testing data from all sources, including third party, remarkably increases quality and allows detecting immediately differences between project as designed and project as executed, as well as the respect of agreed construction standards.
8. Safety and Responsibility: the platform allows to share information about safety and regulations respect on site, among all stakeholders. Project progress and resource tracking are easily accessible to the community being served by the project. Clarity and transparency between parties increase local safety and compliance to environmental protection.

To allow the described use cases we need the following input:
Prime contracts (specifically payments conditions and clauses)
BIM (Building Information Modeling)
IOT & IT data from the construction site, IT systems and machineries

According to a preferred embodiment of the present invention we can certify all these data, distributing the information to the entire ecosystem and enabling all the above uses cases to the stakeholders

Prime contracts contain the payments conditions, outlining main events and triggers for actions. Traditional contracts must be digitally translated to Smart Contracts to enable automatic payments, once conditions are fulfilled.

The system according to a preferred embodiment of the present invention can model a framework capable of extracting libraries from different contracts, that can be used to generate smart contracts. To do this, the Platform exploit collection of System of Systems technologies and modelling languages which are commonly used for engineering simulations. More specifically the language used is SysML (Systems Modeling Language) general-purpose modeling language for systems engineering applications that is intended to provide a standard way to visualize the design of complex systems. The present description mainly refers to SysML, however those skilled in the art will easily appreciate that several other modeling languages and tools could be used instead

The traditional contract must be digitally translated into a SysML model, according to the framework. Once done, it is possible to extrapolate payments conditions, triggers and key events and automatically generate the Smart Contract that will match IOT data ad BIM, enabling payments.

The “paper contract” are transformed into the smart contract in two steps:
1. Modeling a paper-contract in SysML
2. Automated creation of smart-contract from SysML

### Step 1: Modeling a Paper-Contract in SysML

The method and system according to a preferred embodiment of the present invention include using the System Modeling Language (SysML thereafter) for modeling a paper-contract that regulates the business agreement among the actors of the ecosystem of the project, including e.g. contractors, one or more suppliers, financial institutions, regulators. The system exploits the expressive power of SysML to explicitly represent and assert in a formal way those information that are usually expressed in natural language (e.g., in English) in a traditional paper-contract. In the present description we generally refer to “paper contract”, meaning a document or a collection of specification written in “natural language”, i.e. a language which is not ready for the use by a parser. In particular, the system uses SysML to specify:
Who are the parties involved in the paper-contracts (e.g. companies or organizations) and what is their role in the paper-contract (e.g., buyer/project owner, financial institutions, contractors, supplier or sub-suppliers);
What are the obligations of the parties. An obligation is an action that a party commits to take at a specific point in time. An action can be (but are not limited to) delivering a report, delivering some data, delivering some goods or raw material, making a payment, acknowledging that something has been received, taking actions to mitigate a risk, complying with a specific regulation or policy;
What are the constraints of the obligations. Constraints can be (but are not limited to):
   the due date by which a obligation must be satisfied (e.g., deadline for delivering a product);
   the quantity of the delivery (e.g., the cubic meters of delivered raw material);
   the quality of the delivery (e.g., the density of delivered raw material);
   the operational conditions of the delivery (e.g., the production speed of a delivered machinery);
   the geographical position of the destination where material should be delivered to.
   The constraints, more generally, are those contingent parameters which are defined in the specific project and included in the BIM definition. The system and method according to the present invention extract these parameters from the BIM documentation and combine them with the modeled information created according to the SysML rules.
Other conditions specific to the individual projects, such as, for example, penalties to be paid (or deducted from the payment) in case one or more obligations are not met (or just partially met). It includes the exact formula or the algorithm to compute the amount and the magnitude of the penalty.

Currently the conversion step described above, i.e. the transformation from a “paper contract” to a structured modeled contract (e.g. according to SysML rules) is based on a limited number of predefined categories, e.g. a list of obligations or a list of constraints. Possible future developments can provide the option of the system itself interpreting the “paper contract”, for example with Artificial Intelligence tools. In any case the result of the Step 1 is provided as input to the Step 2. The modeled contract, according to a selected Modeling Language must be available for the processing by the system together with the information contained in the BIM documentation. This documentation can be provided in several different format, according to the BIM specification, e.g. a structured table a list of parameters, a descriptive document, structured data taken directly from the file through API, Web API (e.g. REST, SOA, GrapQL) or other types of connections. Future developments can enlarge the number of possible formats of such “BIM compliant” documentations, including Artificial Intelligent produced documentation. In the present description we always refer to SysML as modelling language, but other equivalent tools and languages are possible, such as for example UML, BPMN, Petri Nes, FMC, ORM.

### Step 2 Automated Creation of Smart-Contract From SysML

The method according to a preferred embodiment of the present invention is based on a fully automated approach to turn the SysML model of a “paper-contract” (i.e. a contract in the form of a sequence of SysML-style definition) into the program code of a blockchain smart-contract. The other input for the Step 2 is the set of parameters extracted by the contract and the BIM, as described above. This automatically created program code is then compiled into bytecode or binary-code and then deployed in the blockchain where the smart-contract executes. The smart-contract is meant to represent the computer executable version of a paper-contract. According to a preferred embodiment of the invention, the smart-contract is able to:
Track the progress of the corresponding “paper-contract”, by monitoring what obligations of the “paper-contract” have been met, those obligations that are partially met and those that are not met;
Authorize payments for the contractor to the supplier according to what specified in the “paper-contract” and in the SysML model of the “paper-contract”. The payment is authorized based on whether the delivery constraints are met;
Compute the penalty in case constraints are met, partially met or not met, according to what is specified in the paper-contract and in the SysML model of the paper-contract. This penalty can be automatically deduced from the payment that is authorized by the smart-contract.

In accordance with the method and system according to the present invention, the objective of keeping the performance and progress of a project for works (e.g. a large construction project) under control is fulfilled by collecting data from the automatic systems and sensors on board all plant, equipment and resources contributing to the construction work, such as, for example, plant for the production of concrete, machines for the processing of reinforcing and structural steels, earthmoving machines, cranes and various items of lifting equipment, means for the transport of raw materials and components, and also the human resources working in the context of the construction site (through, for example, wearable devices).

An additional possible source for the collection of data and the monitoring of progress is the use of scans of images generated by drones and digital photo-video systems, which can be superimposed on the progress simulations provided by the BIM system.

According to an embodiment, an additional source of data can come from weather and seismographic sites to check the compatibility of the environmental conditions with performance of the site works.

In a preliminary phase, all these data are incorporated into the platform symmetrically with respect to what is envisaged in the BIM in order to validate the hypothetical times and costs envisaged in the BIM for performance of the work. Once the project is under way, the system can be used to monitor the actual progress of the work, compliance with envisaged technical specifications, and any non-conformities in terms of both quality and safety and environment, in real time and digitally, collecting data from all the connected systems.

The possibility of sharing this data (e.g. through a cloud system and/or within a Blockchain) makes it possible for basic information to be distributed to all stakeholders involved in the project, for example, but not only, clients, funders, company designers, managers and end users, so that everyone can manage their resources in an appropriate, timely and guaranteed way. The possibility of incorporating this platform into a private Blockchain then enables smart-contracts to be developed with all the technical, financial and, if desired, political and social sectors involved in a project. This is a key element for the success of the solution and one of the core aspects of the system according to the present invention, since it enables the real time project tracking and transparency for all the stakeholders according to the bid. The solution also allows to manage and mitigate the risks as well as increase quality and safety.

With a system according to a preferred embodiment of the present invention, it is possible to create a technological platform, mainly aimed at operators in the construction sector, to:
a. objectively assess the feasibility of projects within the envisaged time frame and budget
b. monitor the actual progress of the work in real time through digital surveys
c. share all information in a Blockchain which is accessible to all stakeholders in a profiled way,
d. develop smart-contracts linked to the information validated by the Blockchain,
e. connect the financing, assuring payments through the automation of smart contracts which are validated directly from the IOT of the construction site, with no need of human intervention.

The expected result is to ensure compliance with the programmes and budgets of projects that are currently almost always disregarded, in order to “redeem” the construction sector from its state of unreliability as typically perceived by much of public opinion all over the world. With a system according to a preferred embodiment of the present invention, all information in the entire value chain of the Construction Industry are made available on a permissioned Blockchain, thus unleashing a huge number of use cases and applications ranging from real-time project control and monitoring, instant quantity production and quality control tracking, real-time financial tracking, payment and transaction transparency, to worker and community safety and overall project sustainability. This will significantly improve the overall efficiency and effectiveness of the entire industry for all. In this way all the participants of the Construction Ecosystem will have access to a trusted and immutable source of information that they individually and collectively need to successfully execute and complete their obligations.

The system according to a preferred embodiment of the present invention includes at least one distributed Local Infrastructure (there may also be more than one; for example, several construction sites forming part of the same major work) for the collection of information and a Central Infrastructure for processing and evaluating the information received by the Local Infrastructure. The Central Infrastructure is managed by a server 101 that controls and is connected to a number of detectors 103 set up to measure various activities. These detectors 103 include, for example, sensors and equipment for acquiring and monitoring construction plant, specific control systems present in individual machines and plant, and have the function of acquiring real-time measurements of various process and operating parameters and the status of plant/machinery. Detectors 103 may also include wearable devices (wearable computers) associated with individuals or groups of operators involved in a particular function. Another possible option according to one embodiment of the present invention is to acquire information through images and films captured by appropriate devices (in this case detectors 103 may for example be cameras, remote cameras, web-cams) that are fixed or even better mounted on drones flying over the site or production/industrial site being monitored. In addition, detectors 103 may provide information received from meteorological or seismographic information services, depending on monitoring needs. The data collected are delivered to server 101 through appropriate communication systems that may include, to give just a few examples, local networks, LAN, WAN, Internet, fixed or mobile telephone networks.

In a preferred embodiment of this invention, server 101 is connected to one or more BIM systems 105, each relating to at least one project.

Server 101 also has access to a Blockchain platform 107, where the entire history of the project being monitored (one or more projects) is recorded in a traceable and secure way with corresponding economic quantifications. This structure is by nature shared (and therefore able to be checked by anyone) and unmodifiable. This prevents any attempt at manipulation and makes it possible to place all the economic aspects of a project, from supplier payments to unforeseen costs, just to give a few examples, on a safe and traceable basis. In a preferred embodiment of the present invention, the Blockchain used is that of International Business Machines Corp, but those skilled in the art will easily understand that other platforms or solutions could be used without deviating from the scope of the invention below.

The Central Infrastructure, situated within or controlled by server 101, includes a processing module that receives all data from detectors 103, processes it and integrates it into the BIM system, also acting as a link with Blockchain structure 107.

In a preferred embodiment, server 101 stores and records the processed data in special databases (109). Databases 109 may, for example, include data structures that can manage architectures of even large size (Big Data), with the possible use of Artificial Intelligence (AI) applications. Database 109 also stores one or more contract documents which are then used by the server 101 to automatically generate a Smart-Contract as explained above: the generated Smart-Contract is stored as well in the database 109 and will be used by the server 101 to determine whether the execution of the projects is in compliance with the expected milestones or, on the contrary, if there is a deviation (and quantifying such deviation).

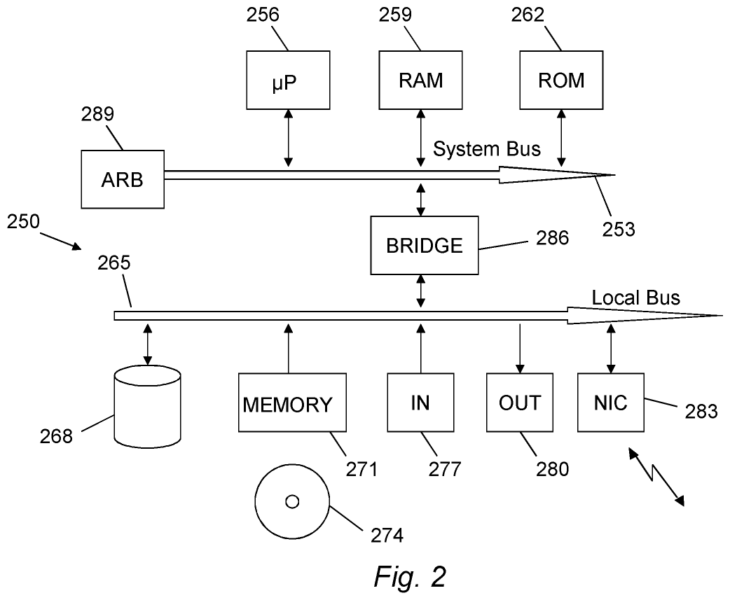

FIG. 2 shows a generic computer used in the system according to the preferred embodiment of the present invention. This generic description includes any equipment with processing capabilities, albeit with different levels of sophistication and functionality (e.g. computers, mobile terminals, servers, network routers, proxy servers). Included in this definition are all devices belonging to the Internet of Things category (also called IoTs), i.e. those devices dedicated to specific operations, e.g. construction site machinery, which are also equipped with data processing capability through a microprocessor and are connected to a central system (server), and optionally between them, by means of a computerized network (e.g. Internet). Computer 250 consists of several units that are connected in parallel to a system bus 253. In detail, one or more microprocessors 256 control the operations of the computer; a RAM memory 259 is used directly as a working memory by microprocessors 256, while a ROM memory 262 contains the basic code for initial loading of the system (bootstrap). Several peripheral units are connected to a local bus 265 by means of suitable interfaces. In particular, these peripheral units may include a mass memory consisting of a hard disk drive 271 and a CD-ROM and/or optical disk drive 274 (e.g. DVD or BlueRay) or any other peripheral or memory device external to the computer. In addition, computer 250 may include input devices 277 (e.g. keyboard, mouse, track-point, USB ports) and output devices 280 (e.g. screen, printer, USB ports). A Network Interface Card 283 is used to connect computer 250 to a network. A bridge unit 286 forms the interface between system bus 253 and local bus 265. Each microprocessor 256 and bridge unit 286 can operate as a “master agent” and requires exclusive access to system bus 253 to transmit information. An arbiter 289 handles requests for access to system bus 253, avoiding conflicts between applicants. Similar considerations will apply to systems that are slightly different or based on different network configurations. Other components, in addition to those described, may be present in specific cases and for particular applications (e.g. handheld computers, mobile phones, etc.).

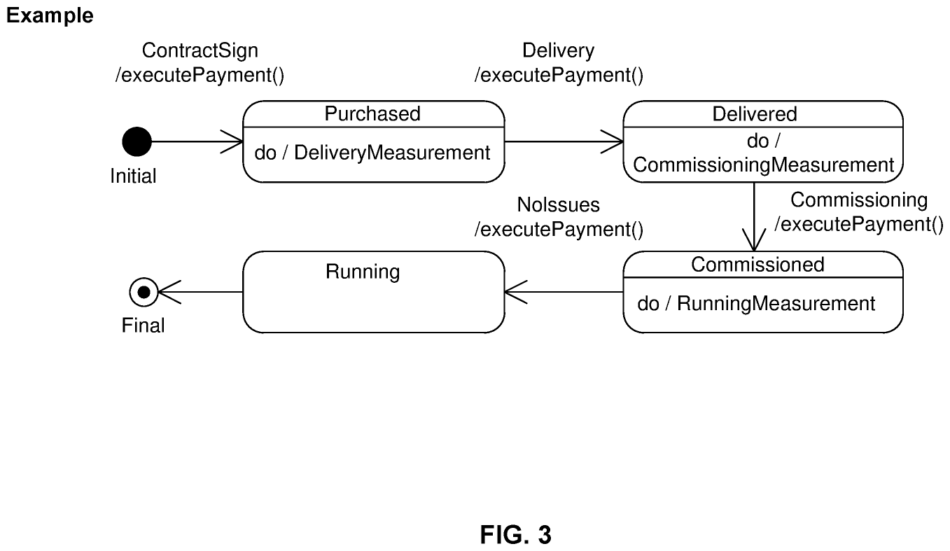

FIG. 3 represent an example of State Machine Phases Diagram used to represent contract phases diagram in SysML.

The diagram models the phases of the process as states. Upon entering a state, the measurement of one (or more) KPI (i.e. Key Performance Indicator) starts. A transition is triggered when an event occurs, i.e. the signal of the delivery, the measurement of KPIs or when a certain amount of time has passed). The transition effect is a payment on the BolckChain, based e.g. on amount, agreement and penalty.

In the present example, with “Events” we mean an occurrence/happening in a certain point in time, e.g. the delivery of a good or the signing of commissioning report.

With “Signals” we mean a particular type of event that encloses information; “Signals” contain data, e.g. a delivery date.

With “Trigger” we mean the specification of the event that triggers a behavior execution, e.g. the measurement and the delivery confirmation of the product triggers a payment (transition from the purchased status to the delivery status). A “trigger” can be specified by a “signal”.

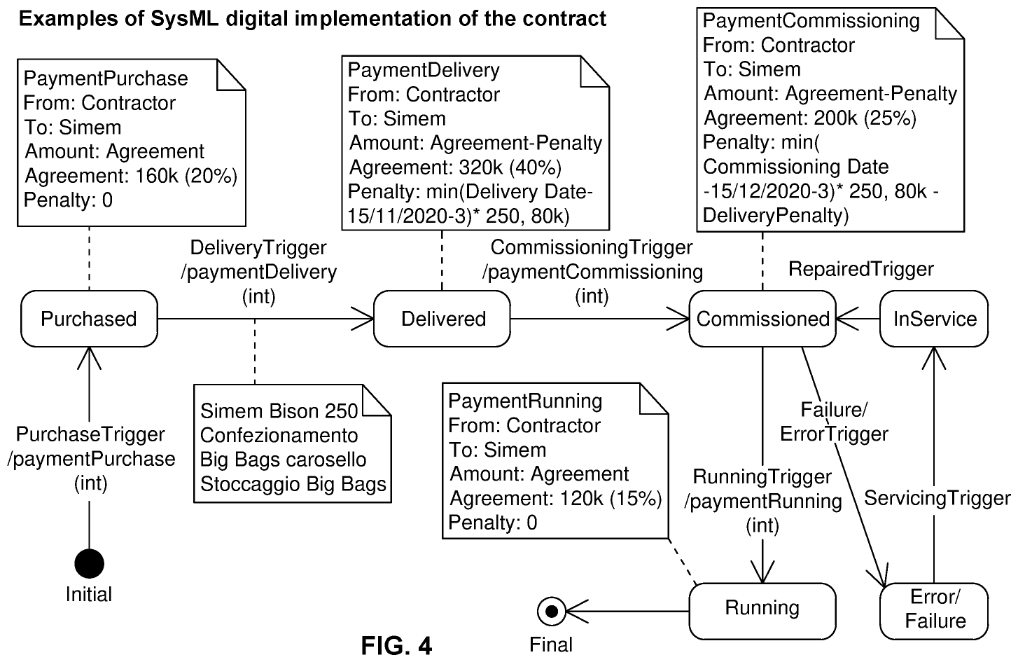

Following the Diagram of FIG. 3, FIG. 4 represents an example of Modelling a contract through Process Phase Flow. The diagram models the phases of the process as states. A transition is triggered when an event occurs: for example, the delivery of the product generates the event “Delivery”, defined by the trigger event “Delivery Trigger”. An “event” can be Timed (when it happens in a specific timeframe) or Untimed (if it happens when conditions are met). The transition effect is the call to a phase function and it is defined in the phase block; at the Smart Contract level, it involves running a specified piece of code.

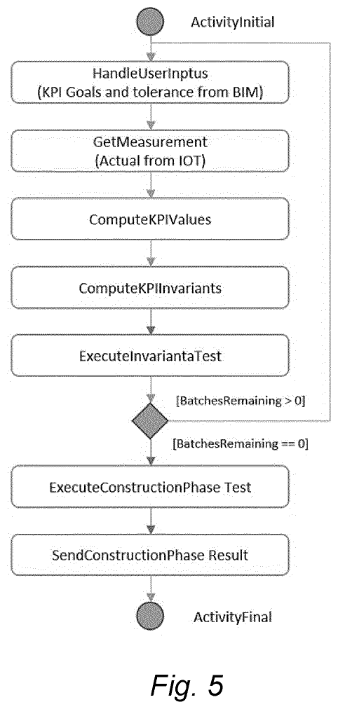

FIG. 5 schematically represents an example of Smart-Contract Management Flow. The diagram models the inner evaluation flow of the construction phase. A hierarchy of KPIs concur to test the production batches:
User parameters and actual measurements are computed into KPI computed values;
Invariants are propositions over a set of KPIs (of a single batch) that must hold true;

The phase Test is the evaluation of the InvariantsTest for all batches. The final result is encapsulated into a signal for the construction Phase KPI Smart Contract.

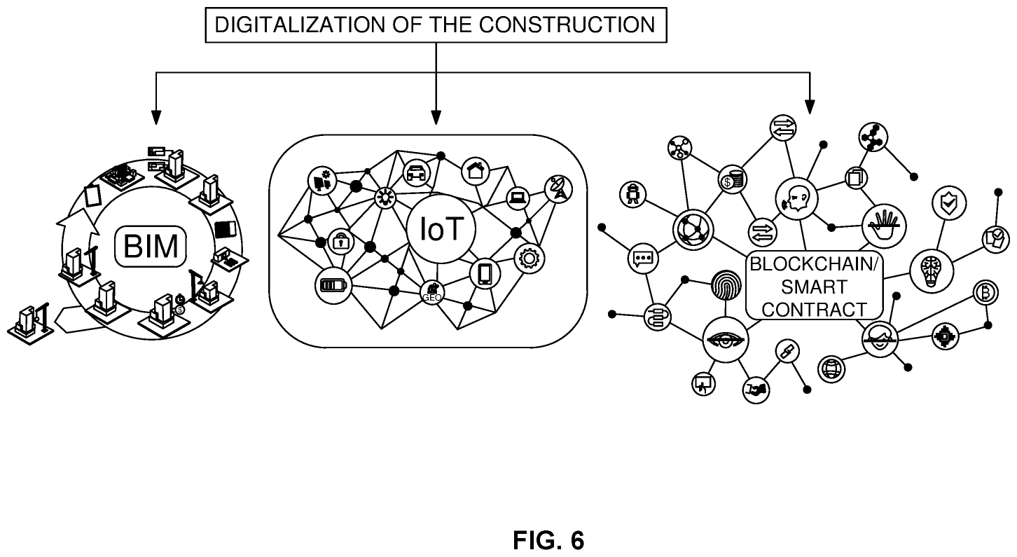

FIG. 6 illustrates a management model according to the present invention; it illustrates the three levels, each of which have their own nodes and interconnections, in which the system is organized: the BIM level, the detector level, via the IoT devices, and the Blockchain.

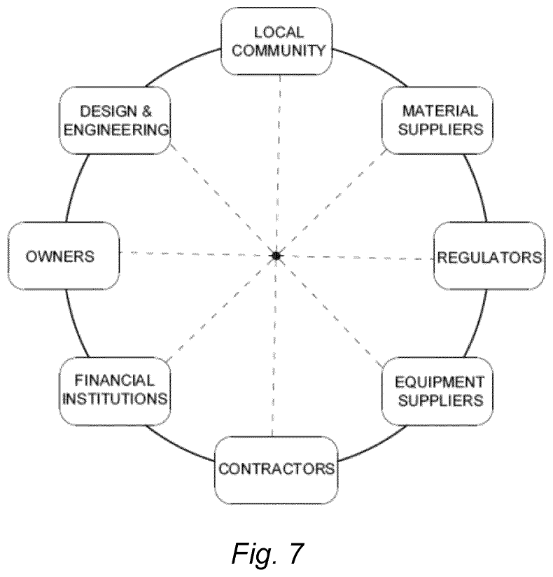

FIG. 7 illustrates a scheme having the architecture of one embodiment of the present invention, with an example based on eight conceptual nodes. The architecture of the Blockchain makes it possible to configure a series of nodes, which for simplicity have currently been imagined to be eight, but obviously could be more or fewer depending on the type of project. For each node it will be possible to profile each category of user, or each user, so that they can access a specific area of the information database. In the example represented in FIG. 7, the “Ecosystem” where a method and system according to a preferred embodiment of the present invention is implemented, includes 8 nodes corresponding to the following categories: Local Community; Material Suppliers; Regulators; Equipment Suppliers; Contractors; Financial Institutions; Owners; Design & Engineering.

Sharing of the information ensures that it is unmodifiable and allows it to be used as legally validated data for the processing of smart contracts for all the parties involved in the project.

Causes of force majeure or unforeseen variants will generate updates to the three levels of the structure in real time, so that all are rescheduled if changes are made to the elements making up the project (times, values, contents, methods, etc.).

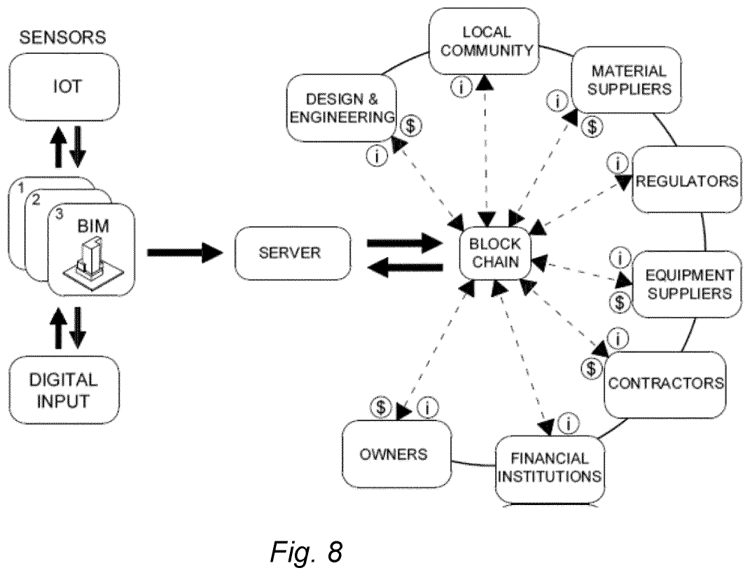

FIG. 8 is a representation of an architecture according to a preferred embodiment of the present invention, with the 8-node Ecosystem of FIG. 7. The architecture according to a preferred embodiment of the present invention, as represented in FIG. 8, includes a server which collects IOT data from the construction site and compare them with the BIM project, in order to automatically track the progress and deviation from the baseline. Embedded smart contracts connect the financial transactions to the construction events and everything is certified and trusted through a permissioned Blockchain.

In FIG. 8, the symbol “i” indicates an exchange of information between the server and the node, through the Blockchain, while the symbol “$” indicates a possible financial transaction.

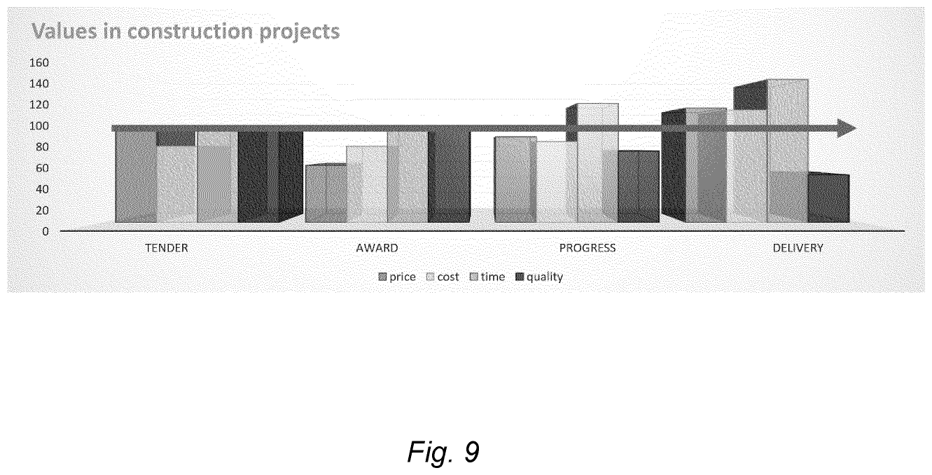

FIG. 9 shows an illustrative graph generated by a system according to a preferred embodiment of the present invention.

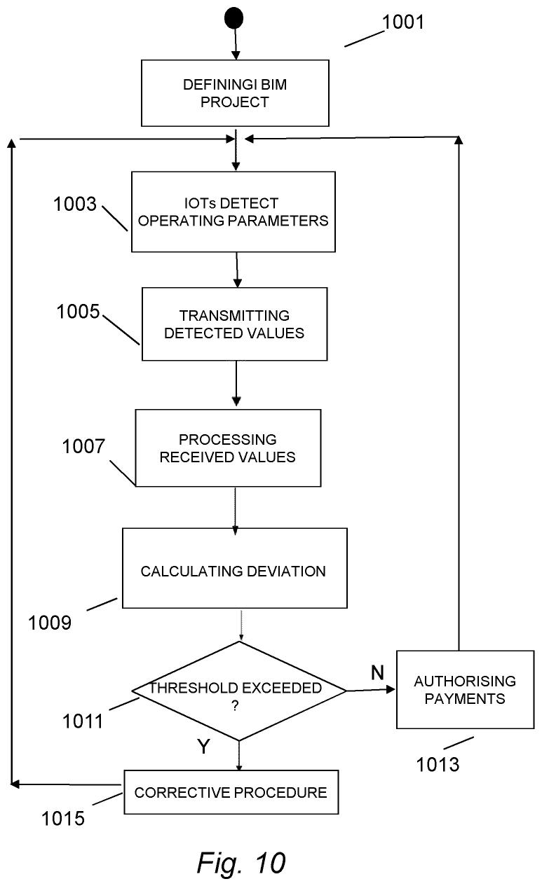

FIG. 10 shows the steps of a method for managing and monitoring the conduct of at least one project according to a preferred embodiment of the present invention. The project, preferably defined and managed by means of a BIM system, comprises a plurality of activities, each having parameters and timing defined in the BIM. The system may also be set up to monitor the conduct of more than one project, each of which will be defined by appropriate parameters and activities. The method is implemented by means of a distributed system comprising a number of detectors 103, connected to a server, each intended to measure at least one operating parameter and transmit the value of the measured operating parameter to a server 101 at predetermined intervals. Detectors 103 include a possible wide variety of devices, at least some of which will be equipped with processing capabilities, and all of which are connected to the server. The method, as illustrated in step 1001, requires as a prerequisite that a project (or several projects) be defined, for example by means of a BIM system (or model) that associates a list of activities with the relative parameters and timings for each project. As mentioned above, the format according to which the project is defined can follow several different rules and notation: obviously the system will be designed to “understand” such rules and notation and to extract the required information in terms of parameters and values. The project includes also the definition of agreed milestones with associated partial payment, the completion of each milestone being the requisite for authorizing the related partial payment. An important part of the present invention is the automatic definition of a Smart Contract which will be used as reference to establish the compliance of the execution of the project steps with the expected milestones or, on the contrary, the deviation (and the quantification of such deviation) as detailed in the following steps. As explained above the automatic generation of the Smart-Contract is performed by means of a digital modeling tool, as for example a tool based on SysML. The input to the digital modelling tool will be 1) the parameters extracted from the BIM documents and 2) the modeled contract according to the Modeling Language (e.g. the SysML) used by the system. Each project will be fully defined by an associated Smart Contract. Detectors 103 are physically located on the site where the project is conducted or have links to that geographical site (e.g. a service that detects meteorological or seismographic data). In any event, they collect data about one or more parameters relating to one or more activities (step 1003). Possible types of detectors 130 also include fixed or mobile devices for the acquisition of images (e.g. mounted on drones). During the execution of the activities making up the project (or each project), detectors 103 send information about the various parameters associated with them (step 1005) at predefined intervals that can obviously be customized and modified, even while work is in progress. Each activity will have one or more detectors 103 associated with it, just as each detector will be associated with one or more activities in a project. According to a preferred embodiment of this invention, detectors 103 mostly comprise so-called IoT (Internet of Things) devices. The details of how this detection and transmission takes place and the times and frequencies of data transmission between the sensors and the server may change according to specific needs. In step 1007, by means of a processing module, server 101 processes the values of the parameters received from the plurality of sensors 103, and determines a deviation from the expected value as defined by the BIM predefined milestones (see step 1009) for each parameter and for the project in general. According to a preferred embodiment of the present invention, the server is connected to a Blockchain system to create and update traceable and non-modifiable documentation for all the activities carried out in the project. The connection with the Blockchain may also be made directly from detectors 103 and may interact with the BIM system. If the server determines an overall value and/or a specific value for a single activity to be deviant (step 1011), a corrective procedure can be put in place (step 1015). Otherwise, the system determines that the milestone associated to the monitored activity is completed and the payment related to the milestone can be authorized by the server (step 1013): the collection and sending of information can continue, returning to step 1003.

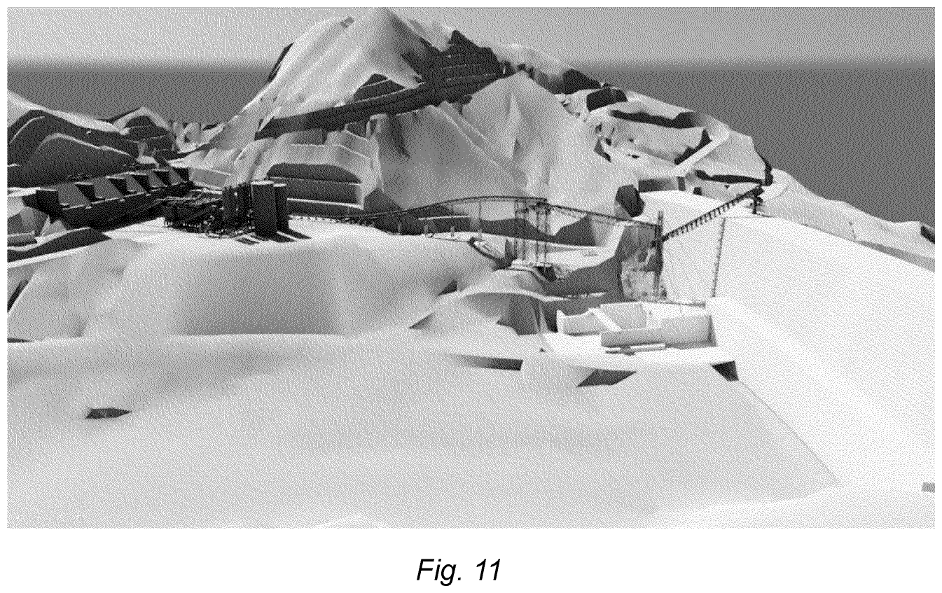

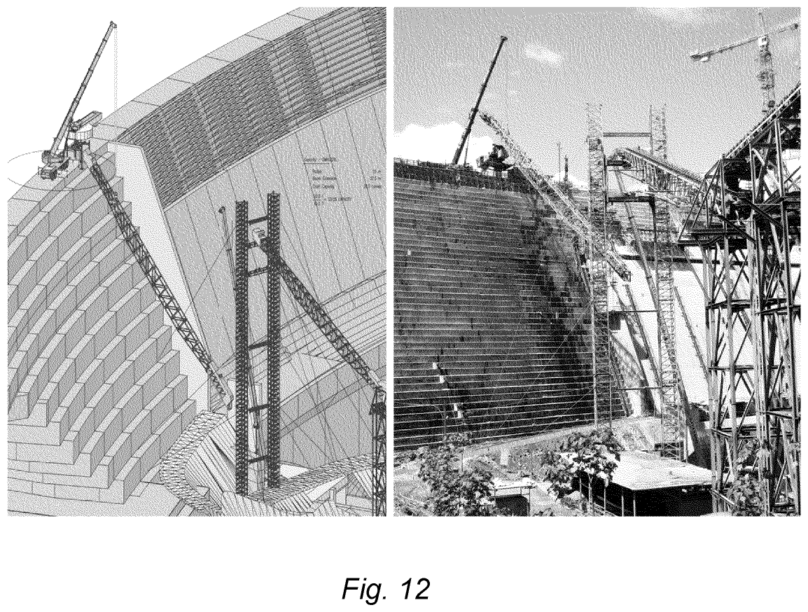

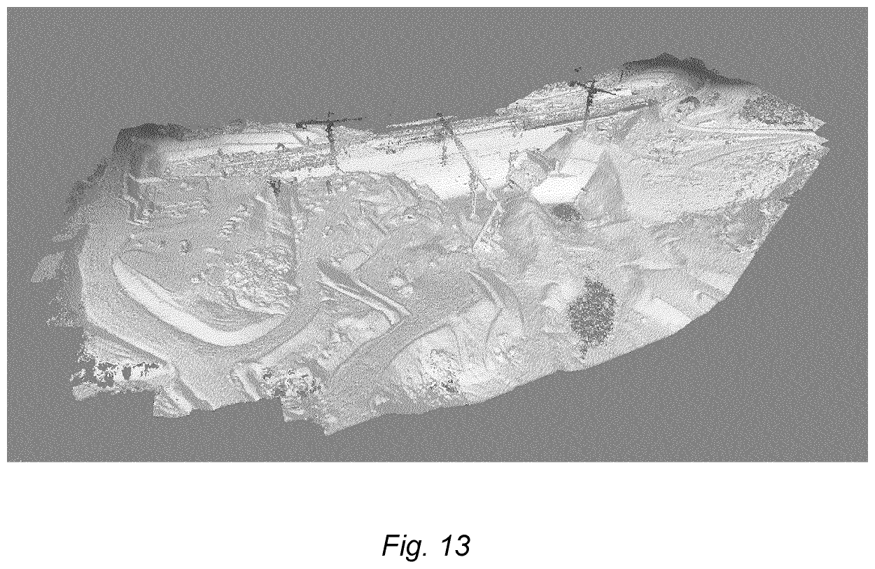

FIGS. 11, 12 and 13 show applications relating to practical examples in which some details of the construction site are represented digitally. These representations are useful to acquire images through, for example, cameras installed on drones, for the purpose of comparing them with other available information.

In practice, the details of execution can in any event be varied in an equivalent manner with regard to the individual elements described and illustrated and the nature of the tools indicated (e.g the Modelling Language tools), without deviating from the concept of the solution adopted, and therefore remaining within the limits of protection conferred by the present patent. A person skilled in the art would be able to make many changes to the solution described above in order to meet local or specific requirements. In particular it should be clear that, although implementing details have been provided for one or more preferred embodiments, omissions, substitutions or variations of some specific features or steps of the method described may be made on account of design or implementation requirements.

By way of example, the hardware structures may take on a different appearance or include different modules; the term computer includes any apparatus (e.g. telephones, PDAs, machines and sensors of any type) with the processing capacity to run software programs or parts of them. Programs may be structured differently or implemented in any form. In the same way, memories may take multiple forms or be replaced by equivalent units (not necessarily comprising tangible media). Programs may take any suitable form to perform their functions and may be written in any programming language or presented in the form of software, firmware or microcode, both object code and source code. The programs themselves may be stored on any type of medium, provided that it can be read by computer; by way of example, the media may be: hard disks, removable disks (e.g. CD-ROMs, DVDs or Blue Ray Disks), tapes, cartridges, wireless connections, networks, telecommunication waves; the media may for example be electronic, magnetic, optical, electromagnetic, mechanical, infrared or semiconductor. In any event, the solution according to this invention may be implemented by means of software, hardware (also incorporated in chips or semiconductor materials) or a combination of hardware and software.

The principle whereby monitoring the performance of activities forms part of a structured process applies to any field in which there is a need to keep the progress of activities under control and ensure compliance between actually measured values and those foreseen in advance, provided that the process generating these values can be monitored and the values can be measured.

1. Method for managing and monitoring the execution of at least one project comprising a plurality of activities, by means of a distributed system comprising a plurality of detectors connected with a server, each of the plurality of detectors being adapted to measure at least one operating parameter related to one of the plurality of activities and to transmit the value of the at least one measured operating parameter at predetermined time intervals to the server, the method comprising the steps of:
storing, for each project, in a database accessible from the server, at least one project definition document, defining a plurality of project specific constraints and at least one modeled contract document, each modeled contract document containing modeled definitions of at least two parties and a plurality of obligations related to the plurality of activities, the modeled definitions being compliant to a predetermined digital modeling language;
for each project automatically generating, by means of a digital modelling system adapted to interpret the predetermined digital modelling language, a smart contract, the smart contract being based on the at least one project definition and the at least one modeled contract document, the smart contract defining a list of activities, each activity having a plurality of associated operating parameters and for each associated operating parameter an expected value based on the time elapsed since the beginning of the activity, the smart contract defining the payments to be authorized when the expected values are reached, each of the operating parameters being associated with at least one of the plurality of sensors;
processing, in a traceable and secure way, by the server the values of the parameters received from the plurality of sensors and calculating for each parameter a deviation from the expected value;
determining by the server a value representative of the total deviation with respect to the plurality of expected values;
responsive to a predetermined threshold being exceeded by the value representative of the total deviation, executing a predetermined corrective action procedure; or
responsive to the predetermined threshold not being exceeded by the value representative of the total deviation, authorizing the payment associated to the expected values.

2. The method for managing and monitoring execution according to claim 1, wherein processing in a traceable and secure way is performed by means of a Blockchain.

3. The method of claim 1, wherein the predetermined digital modeling language is System Modelling Language, SysML.

4. The method of claim 1, wherein for each activity, the plurality of associated operating parameters include one or more of the following:
a due date by which the activity must be completed;
a quantity of the delivery (e.g., the cubic meters of delivered raw material);
one or more parameters indicative of the quality of the delivery (e.g., the density of delivered raw material);
one or more operational conditions of the delivery (e.g., the production speed of a delivered machinery);
a geographical position of the destination where material should be delivered.

5. The method for managing and monitoring execution according to claim 1, wherein the smart contract defines at least one milestone associated to each of the plurality of activities, each milestone being associated to at least one financial transaction, and wherein the method further comprises:
monitoring the real time progress of the plurality of activities to determine whether a milestone is reached;
responsive to a milestone being reached, authorizing the at least one associated financial transaction.

6. The method for managing and monitoring execution according to claim 1, wherein the plurality of detectors comprises one or more of the following: an IoT device; a fixed image acquisition device, an image acquisition device installed on a drone, a personal wearable device, a device capable of providing meteorological and/or seismographic information of a geographical area linked to the at least one project.

7. The method for managing and monitoring execution according to claim 1, wherein the activities of the at least one project are defined by means of a Building Information Modeling (BIM) system.

8. The method for managing and monitoring execution according to claim 1, wherein the server and/or at least one of the detectors are connected and exchange information with a Blockchain system.

9. A computer program adapted to perform a method for managing and monitoring the execution of at least one project comprising a plurality of activities, according to claim 1, when the program is executed on a data processing system.

10. A distributed system comprising one or more components adapted to implement a method for managing and monitoring the execution of at least one project comprising a plurality of activities, according to claim 1.
